(19) United States
(12) Patent Application Publication
(10) Pub. No.: US 2012/0204535 A1
(43) Pub. Date: Aug. 16, 2012

(54) AUGMENTED EXPANDER CYCLE

(75) Inventors: Alan B. Minick, Madison, AL (US); David C. Gregory, Covington, WA (US)

(73) Assignee: PRATT & WHITNEY ROCKETDYNE, INC., Canoga Park, CA (US)

(21) Appl. No.: 13/027,868

(22) Filed: Feb. 15, 2011

(51) Int. Cl. F02K 9/48

(52) U.S. Cl. 60/246

(57) ABSTRACT

A rocket engine includes a thrust chamber having a cooling channel, which is adapted to provide sustained cracking conditions for a fluid (e.g., kerosene) within the cooling channel under steady-state engine operating conditions. An augmenter having a fluid input communicates with an output of the cooling channel, and an output of the augmenter is in fluid communication with a turbine. A pump is mechanically coupled to the turbine, and provides fluid flow to the inlet of the cooling channel.

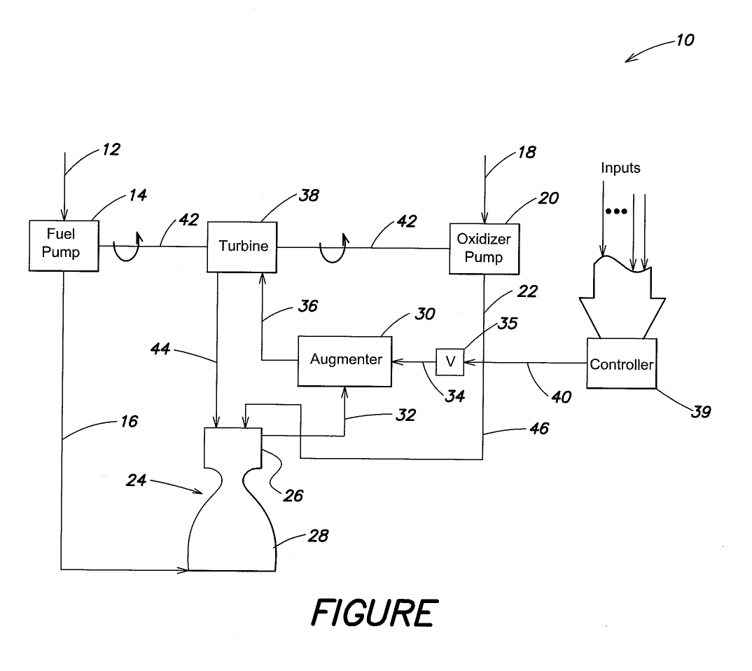

### BACKGROUND

1. Technical Field

The present invention relates to bipropellant rocket engines, and in particular to an augmented expander cycle rocket engine that utilizes cracked Hydrocarbon fuel.

2. Background Information

The expander cycle is a power cycle of a bipropellant rocket engine, where the fuel is heated before it is combusted, usually with heat from the main combustion chamber and/or the nozzle and used to drive the propellant pumps. In a typical expander, as the fuel passes through coolant passages in the walls of the combustion chamber/nozzle, it gains heat, increasing the enthalpy of the fluid. The fuel then expands through one or more turbines to initiate and maintain turbopump operation. After leaving the turbine, the fuel is injected into the combustion chamber where it is mixed with the oxidizer and burned to produce thrust for the vehicle. It should be noted that either or both propellants may be used to cool the combustion chamber and/or nozzle and drive the turbine(s).

A typical expander cycle thrust is limited by the heat transfer from the combustion chamber and nozzle to the propellants which is in turn limited by the surface area of the combustion chamber and nozzle. Since the factors determining engine thrust include the throat area, the thrust increases as a factor of the radius squared while the surface area only increases proportional to the radius. In a simple representation the size of a (fixed expansion ratio) bell-shaped nozzle increases with increasing thrust, the nozzle surface area (from which heat can be extracted to expand the fuel) increases with the radius. However, the energy gain required to drive the turbines increases as the square of the radius. Additional factors influence the values and relationships but remain subject to this relationship between surface area and throat area relative to the throat and resulting gas path radii. Because the heat energy from the chamber is used to drive the propellant pumps via a turbine, expander cycles are limited in maximum operating pressure, especially at larger thrust classes.

There is a need for an expander cycle engine that allows for higher thrust.

### BRIEF DESCRIPTION OF THE DRAWINGS

The FIGURE is a simplified system block diagram illustration of an augmented expander cycle rocket engine.

### DETAILED DESCRIPTION

An augmented kerosene expander cycle engine 10 includes a first propellant supply line 12 that provides kerosene to a first pump 14, which provides pressurized liquid kerosene via a flow line 16. A second liquid oxidizer supply line 18 to a second pump 20, which provides pressurized liquid oxidizer via a flow line 22.

The pressurized kerosene in the flow line 16 is routed through coolant passages within peripheral walls (e.g., a cooling jacket) of a combustion chamber/nozzle assembly 24, which comprises a combustion chamber 26 and a nozzle 28. The coolant passages may be located on the peripheral walls of the combustion chamber 26, the peripheral walls of the nozzle 28, or both. Heat from the combustion chamber 26 and/or the nozzle 28 heat the liquid kerosene circulating through the peripheral coolant passages. The conditions (e.g., temperature, pressure, catalyst, etc) required to provide sustained cracking of the kerosene during steady-state operation of engine may be established in the cooling passages, resulting in cracking of the kerosene which may be sustained as a liquid and/or supercritical fluid. Steady-state engine operating conditions are generally considered to be when the engine is at any one non-zero power point for an extended period of time (seconds). However, it is contemplated that the engine may also be considered to be in steady-state operation when combustion of the propellants is sufficient to sustain operation of the engine system. The endothermic reaction associated with cracking of the kerosene (or other hydrocarbon propellant) may provide additional cooling of the chamber or nozzle.

An augmenter 30 receives the cracked kerosene via a flow line 32, and liquid oxidizer (e.g., liquid oxygen) via a flow line 34 from a valve 35. The augmenter adds heat to the cracked kerosene coolant through combustion with the oxidizer, and the output from the augmenter is provided in a flow line 36 to a turbine assembly 38. The oxidizer is reacted with the kerosene within the augmenter to produce combustion products and heat energy; the heat increases the temperature of the fuel flow providing energy to drive the turbine. The amount of pressurized liquid oxidizer introduced into the augmenter is controlled by the valve 35, and determines the temperature and added energy of the fuel flow provided by the augmenter. A controller 39 receives various system input signals and provides a command signal on a line 40 to provide the desired amount of pressurized liquid oxidizer to the augmenter. The augmenter may include devices to promote mixing and/or combustion stability of a portion of the fuel and oxidizer. It is understood that other valves typically required for engine operation are omitted in the interest of ease of illustration.

The turbine assembly 38 drives the first and second pumps 14, 20 via one or more direct or geared drive shaft(s) 42. While the first and second pumps may be connected to the same drive shaft, it is contemplated that the pumps may be connected directly or indirectly to the turbine assembly by different shafts. In addition, the turbine assembly may include one turbine that drives both pumps, or a first turbine that drives the first pump and a second turbine that drives the second pump. The cracked kerosene output from the turbine 38 is input to the combustion chamber 26 via a flow line 44. It is combusted with the oxidizer received via flow line 46, and the combusted gases are exhausted through the nozzle 28 to provide thrust.

The augmenter adds heat to the at least partially cracked kerosene coolant to provide a desired amount of energy to the turbine. Although the description as previously discussed using kerosene as the hydrocarbon fuel, it is contemplated that other hydrocarbon fuels that can be cracked may also be used.

Although this invention has been shown and described with respect to the detailed embodiments thereof, it will be understood by those skilled in the art that various changes in form and detail thereof may be made without departing from the spirit and scope of the claimed invention.

What is claimed is:

1. An engine, comprising:
a thrust chamber having a cooling channel, wherein the cooling channel is adapted to provide sustained cracking conditions for a fluid within the cooling channel under steady-state engine operating conditions;
an augmenter having a fluid input in fluid communication with an output of the cooling channel;
a turbine having an input in fluid communication with an output of the augmenter;
a pump mechanically coupled with the turbine, where the pump is in fluid communication with an inlet of the cooling channel.

2. The engine of claim 1, where the thrust chamber comprises a combustion chamber.

3. The engine of claim 1, where the thrust chamber comprises a nozzle.

4. The engine of claim 1, where the thrust chamber comprises a main combustion chamber and a nozzle.

5. The engine of claim 1, where the pump is in fluid communication with the cooling channel.

6. The engine of claim 1, where the output of the cooling channel is in fluid communication with the input of the augmenter.

7. An engine, comprising:
a thrust chamber having a cooling channel;
an augmenter having a fluid input in fluid communication with an output of the cooling channel, wherein the augmenter is adapted to provide sustained cracking conditions for a fluid within the cooling channel under steady-state engine operating conditions;
a turbine having an input in fluid communication with an output of the augmenter;
a pump mechanically coupled with the turbine, where the pump is in fluid communication with the cooling channel.

8. The engine of claim 7, where the thrust chamber comprises a main combustion chamber.

9. The engine of claim 7, where the thrust chamber comprises a nozzle.

10. The engine of claim 7, where the thrust chamber comprises a main combustion chamber and a nozzle.

11. The engine of claim 7, where the pump is in fluid communication with the cooling channel.

12. The engine of claim 7, where the output of the cooling channel is in fluid communication with the input of the augmenter.

13. A rocket engine, comprising:
a first pump that receives liquid oxidizer and provides pressurized liquid oxidizer;
a second pump that receives liquid kerosene and provides pressurized liquid kerosene;
a combustion chamber and nozzle assembly having coolant flow passages arranged in its peripheral wall, where the passages receive the pressurized liquid kerosene via a coolant inlet, circulate and heat the pressurized liquid kerosene and output cracked kerosene via a coolant outlet;
an augmenter that receives the cracked kerosene and a portion of the pressurized liquid oxidizer to add energy to the cracked kerosene flow, and outputs a high energy kerosene flow; and
a turbine assembly that receives and extracts energy from the high energy kerosene flow to drive the first and second pumps, and provides a turbine output kerosene flow;
where the combustion chamber and nozzle assembly receives and mixes the turbine output kerosene flow and the pressurized liquid oxidizer to provide a resultant mixture, and combusts the resultant mixture to provide thrust.

14. The rocket engine of claim 13, comprising a shaft driven by the turbine assembly and connected to the first pump and the second pump.

15. The rocket engine of claim 13, where the turbine assembly comprises a first turbine that drives the first pump and a second turbine that drives the second pump.

16. The rocket engine of claim 13, where the turbine assembly comprises a turbine that drives both the first pump and the second pump.

17. The rocket engine of claim 13, where combustion chamber and nozzle assembly comprises a convergent/divergent nozzle.

18. The rocket engine of claim 17, where the combustion chamber outputs a sustained flow of cracked kerosene via the coolant outlet during steady-state operation of the engine.
